(19) United States
(12) Patent Application Publication
(10) Pub. No.: US 2022/0061617 A1
(43) Pub. Date: Mar. 3, 2022

(54) MOBILE ROBOT

(71) Applicant: LG ELECTRONICS INC., Seoul (KR)

(72) Inventor: Jaejung BYUN, Seoul (KR)

(73) Assignee: LG ELECTRONICS INC., Seoul (KR)

(21) Appl. No.: 17/418,499

(22) PCT Filed: Dec. 27, 2019
(86) PCT No.: PCT/KR2019/018621

§ 371 Date: Jun. 25, 2021

(30) Foreign Application Priority Data
Dec. 28, 2018 (KR) 10-2018-0171553

(51) Int. Cl. A47L 9/28; B25J 9/16; B25J 11/00; A47L 9/00

(52) U.S. Cl. CPC A47L 9/2852; B25J 9/1676; B25J 9/1666; B25J 11/0085; A47L 2201/06; A47L 9/2894; A47L 9/2826; A47L 2201/04; A47L 9/009

(57) ABSTRACT

Disclosed is a mobile robot including a driver configured to move a main body, a memory configured to store a first obstacle map of a cleaning area, a communication interface configured to communicate with a second mobile robot, and a controller configured to, when receiving a second obstacle map of the cleaning area from the second mobile robot, perform calibration on the received second obstacle map on the basis of an artificial mark on the stored first obstacle map.

### TECHNICAL FIELD

The present disclosure relates to a mobile robot, and more particularly to a method of controlling a plurality of mobile robots such that the robots share a map with each other and perform cleaning in cooperation with each other.

### BACKGROUND

Robots have been developed for industrial purposes and have taken charge of portions of factory automation. In recent years, the fields in which robots are utilized have further expanded. As a result, medical robots, aerospace robots, etc. have been developed. In addition, home robots that may be used in general houses haven been manufactured. Among such robots, a robot capable of autonomously traveling is called a mobile robot. A representative example of mobile robots used in general houses is a robot cleaner.

Various kinds of technologies of sensing the environment and a user around a robot cleaner using various sensors provided in the robot cleaner are known. In addition, technologies in which a robot cleaner learns and maps a cleaning area by itself and detects a current position on a map are known. A robot cleaner capable of performing cleaning while traveling a cleaning area in a predetermined manner is known.

A conventional robot cleaner detects the distance to an obstacle or a wall and maps the environment around the cleaner using an optical sensor, which is advantageous in detecting a distance, detecting terrain, and obtaining an image of an obstacle.

In a conventional method of controlling a robot cleaner disclosed in Korean Patent Laid-open Publication No. 10-2014-0138555, a map is generated through a plurality of sensors.

When a plurality of robots shares a map, each of the robots perceives a position with respect to an initial starting point. However, since each of the robots has its own starting point, it is not capable of perceiving position information or environment information about other robots.

In particular, in the case in which respectively different types of robots are used, respectively different maps are generated for the same cleaning area and the sizes and coordinate directions of the maps are different from each other due to the difference in map-generating method between the robots and the difference in type and sensitivity between the sensors. In addition, in the case in which respectively different maps are generated, it is difficult to share position information and environment information, thus making it impossible to perform cooperative cleaning.

In order to efficiently perform cooperative cleaning using a plurality of mobile robots, each of the mobile robots needs to detect the position of another mobile robot. To this end, a position sensor, such as an ultrasonic sensor or a radar, may be additionally used to detect the position of another mobile robot. However, when the distance from the other mobile robot increases, it may be difficult to detect the position of the other mobile robot. In order to overcome this shortcoming, a high-performance sensor may be used to accurately detect the position of another mobile robot that is far away. However, the use of a high-performance sensor increases the cost of manufacturing the product.

### SUMMARY

### Technical Problem

Therefore, the present disclosure has been made in view of the above problems, and it is an object of the present disclosure to provide a mobile robot for efficiently and accurately matching different cleaning maps that are used by a plurality of mobile robots in the same space.

It is another object of the present disclosure to provide a plurality of mobile robots and a control method thereof, in which even when a plurality of mobile robots uses respectively different cleaning maps of the same space, the mobile robots may easily recognize the positions thereof relative to each other and may share position information and environment information without additionally sharing a feature map (a simultaneous localization and mapping (SLAM) map).

It is a further object of the present disclosure to provide a plurality of mobile robots and a control method thereof, in which a plurality of mobile robots may efficiently perform cooperative cleaning while detecting the positions of other mobile robots within a designated space without the necessity to install position sensors thereon.

### Technical Solution

In accordance with the present disclosure, the above objects can be accomplished by the provision of a mobile robot configured to match a received obstacle map and an obstacle map thereof using an artificial mark.

In accordance with an aspect of the present disclosure, there is provided a mobile robot including a driver configured to move a main body, a memory configured to store a first obstacle map of a cleaning area, a communication interface configured to communicate with a second mobile robot, and a controller configured to, when receiving a second obstacle map of the cleaning area from the second mobile robot, perform calibration on the received second obstacle map on the basis of an artificial mark on the stored first obstacle map.

The controller may perform calibration on the second obstacle map by calculating a conversion value for scaling, rotating, or moving at least one of the first obstacle map or the second obstacle map such that a first artificial mark on the first obstacle map and a second artificial mark on the second obstacle map match each other.

The controller may perform calibration on the second obstacle map by calculating a conversion value for scaling, rotating, or moving at least one of the first obstacle map or the second obstacle map such that a plurality of first artificial marks on the first obstacle map and a plurality of second artificial marks on the second obstacle map match each other.

The controller may perform calibration on the second obstacle map by calculating a conversion value for scaling, rotating, or moving at least one of the first obstacle map or the second obstacle map such that the position and shape of a first artificial mark on the first obstacle map and the position and shape of a second artificial mark on the second obstacle map match each other.

The controller may detect the position of the second mobile robot using a second obstacle map on which calibration has been performed, and may transmit a cleaning command, generated based on the position of the second mobile robot, and information about the position of the main body to the second mobile robot.

The information about the position of the main body may be marked on the second obstacle map on which calibration has been performed.

The cleaning command transmitted to the second mobile robot may be a cleaning command for a specific region selected based on information about the position of the main body, information about an obstacle on the first obstacle map or the second obstacle map, and information about the position of the second mobile robot, or may be a cleaning command for instructing the second mobile robot to travel along a route along which the main body has traveled.

When the calibration is completed, the controller may recognize the position coordinates of the second mobile robot corresponding to a wireless signal, received from the second mobile robot, using the first obstacle map.

The mobile robot may further include a sensor configured to collect information about the artificial mark with respect to the cleaning area.

The controller may analyze images collected from the cleaning area, may determine an immovable figure among the collected images, and may specify at least one of figures determined to be immovable as an artificial mark.

The controller may analyze images collected from the cleaning area, and may specify at least one of figures determined to be marked on a wall or a ceiling among the collected images as an artificial mark.

In accordance with another aspect of the present disclosure, there is provided a plurality of mobile robots including a first mobile robot and a second mobile robot, the first mobile robot receiving a second obstacle map of a cleaning area from the second mobile robot, performing calibration on the received second obstacle map on the basis of an artificial mark on a first obstacle map prestored therein, and transmitting conversion data corresponding to the calibration to the second mobile robot, and the second mobile robot applying the conversion data to the second obstacle map thereof, recognizing the position coordinates corresponding to a wireless signal received from the first mobile robot, and generating a cleaning command.

The first mobile robot may perform calibration on the second obstacle map by calculating a conversion value for scaling, rotating, or moving at least one of the first obstacle map or the second obstacle map such that a first artificial mark on the first obstacle map and a second artificial mark on the second obstacle map match each other.

The first mobile robot may perform calibration on the second obstacle map by calculating a conversion value for scaling, rotating, or moving at least one of the first obstacle map or the second obstacle map such that the position and shape of a first artificial mark on the first obstacle map and the position and shape of a second artificial mark on the second obstacle map match each other.

### Advantageous Effects

According to the mobile robot of the present disclosure, there are one or more effects as follows.

First, different types of cleaning maps, which are collected by different types of mobile robots with respect to the same space, may be efficiently and accurately matched with each other using an artificial mark.

Second, it is possible to share cleaning maps, environment information, and position information between the same type of mobile robots and between different types of mobile robots.

Third, a plurality of mobile robots may efficiently perform cooperative cleaning while detecting the positions of other mobile robots within a designated space without the necessity to install position sensors thereon.

Fourth, even when mobile robots are of different types from each other and thus use respectively different cleaning maps of the same space, the mobile robots may easily recognize the positions thereof relative to each other without additionally sharing a feature map (a simultaneous localization and mapping (SLAM) map). As a result, a cooperation scenario may be efficiently modified or updated according to the positions of the mobile robots relative to each other even while the mobile robots are performing cooperative cleaning.

However, the effects achievable through the present disclosure are not limited to the above-mentioned effects, and other effects not mentioned herein will be clearly understood by those skilled in the art from the appended claims.

### BRIEF DESCRIPTION OF DRAWINGS

FIG. 1 is a perspective view showing an example of a robot cleaner according to the present disclosure.

FIG. 2 is a plan view of the robot cleaner shown in FIG. 1.

FIG. 3 is a side view of the robot cleaner shown in FIG. 1.

FIG. 4 is a block diagram showing the components of a robot cleaner according to an embodiment of the present disclosure.

FIG. 5A is a conceptual view showing network communication between a plurality of robot cleaners according to an embodiment of the present disclosure, and FIG. 5B is a conceptual view showing an example of the network communication shown in FIG. 5A.

FIG. 5C is a view for explaining following control between a plurality of robot cleaners according to an embodiment of the present disclosure.

FIG. 6 is a representative flowchart for explaining a method of recognizing the positions of a plurality of robot cleaners relative to each other in order to perform cooperative/following cleaning according to an embodiment.

FIG. 7 is a view showing the operation of robot cleaners according to an embodiment of the present disclosure, which perform cleaning while communicating with each other using respectively different obstacle maps in which the positions thereof are marked.

FIG. 8 is a flowchart for explaining a calibration process for unifying the coordinate systems of mutually different obstacle maps according to an embodiment of the present disclosure.

FIGS. 9A, 9B, 9C, 9D and 9E are conceptual views showing processes of matching mutually different obstacle maps through scaling, rotation, and movement according to an embodiment of the present disclosure.

FIG. 10 is a flowchart for explaining a method of recognizing the positions of a plurality of robot cleaners relative to each other in order to perform cooperative/following cleaning according to another embodiment of the present disclosure.

### DETAILED DESCRIPTION

Advantages and features of the present disclosure and methods for achieving them will be made clear from the embodiments described below in detail with reference to the accompanying drawings. The present disclosure may, however, be embodied in many different forms, and should not be construed as being limited to the embodiments set forth herein. Rather, these embodiments are provided so that this disclosure will be thorough and complete, and will fully convey the scope of the present disclosure to those skilled in the art. The present disclosure is merely defined by the scope of the claims. Like reference numerals refer to like elements throughout the specification.

Spatially relative terms such as “below”, “beneath”, “lower”, “above”, or “upper” may be used herein to describe one element's relationship to another element as illustrated in the figures. It will be understood that such spatially relative terms are intended to encompass different orientations of the device in addition to the orientation depicted in the figures. For example, if the device in one of the figures is turned over, elements described as “below” or “beneath” other elements would then be oriented “above” the other elements. The exemplary terms “below” or “beneath” can, therefore, encompass both positional relationships of above and below. Since the device may be oriented in another direction, spatially relative terms may be interpreted in accordance with the orientation of the device.

The terminology used in the present disclosure is for the purpose of describing particular embodiments only, and is not intended to limit the disclosure. As used in the disclosure and the appended claims, the singular forms “a”, “an” and “the” are intended to include the plural forms as well, unless the context clearly indicates otherwise. It will be further understood that the terms “comprises” and/or “comprising”, when used in this specification, specify the presence of stated components, steps, and/or operations, but do not preclude the presence or addition of one or more other components, steps, and/or operations.

Unless otherwise defined, all terms (including technical and scientific terms) used herein have the same meanings as those commonly understood by one of ordinary skill in the art. It will be further understood that terms such as those defined in commonly used dictionaries should be interpreted as having meanings consistent with their meanings in the context of the relevant art and the present disclosure, and are not to be interpreted in an idealized or overly formal sense unless expressly so defined herein.

A mobile robot 100 according to the present disclosure may be a robot that is capable of autonomously traveling using wheels or the like, e.g. a home robot for household uses, a robot cleaner, or the like.

Hereinafter, a robot cleaner according to the present disclosure will be described in more detail with reference to the drawings.

Embodiments disclosed in this specification will be described below in detail with reference to the accompanying drawings. It should be noted that technological terms used herein are used merely to describe a specific embodiment, not to limit the scope of the present disclosure.

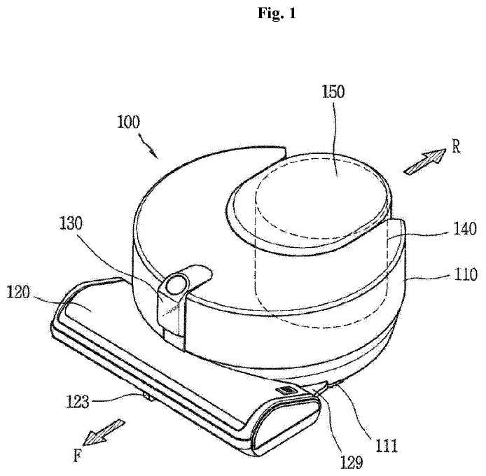

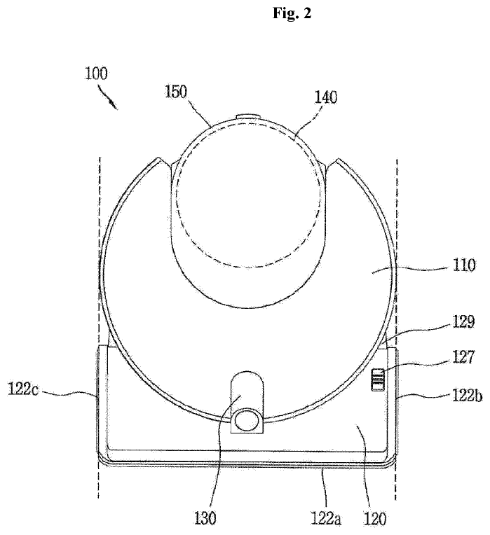

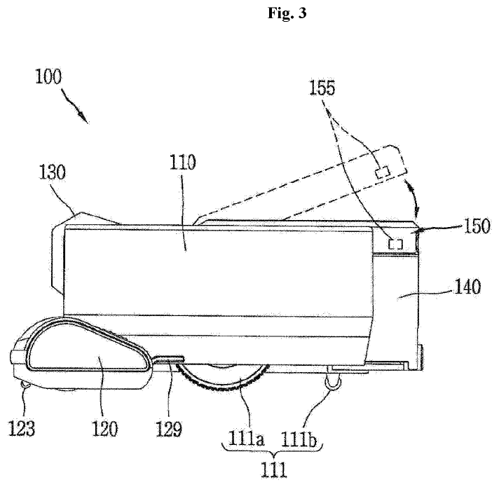

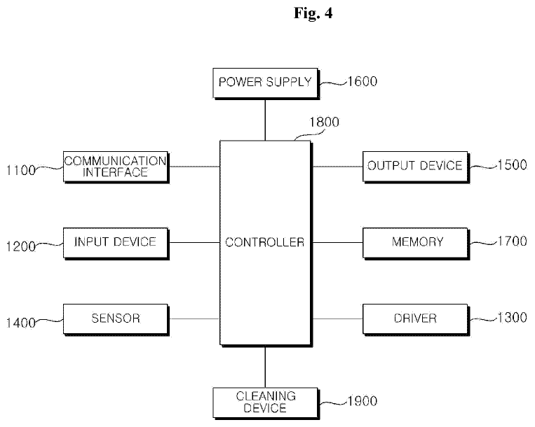

FIG. 1 is a perspective view showing an example of the mobile robot 100 according to the present disclosure, FIG. 2 is a plan view of the mobile robot 100 shown in FIG. 1, and FIG. 3 is a side view of the mobile robot 100 shown in FIG. 1.

In this specification, the terms “mobile robot”, “robot cleaner”, and “autonomous-driving cleaner” may have the same meaning. In addition, the plurality of cleaners described herein may commonly include at least some of the components to be described below with reference to FIGS. 1 to 3.

Referring to FIGS. 1 to 3, the robot cleaner 100 may perform a function of cleaning the floor while autonomously traveling in a predetermined area. Here, the floor cleaning may include suctioning dust (which includes foreign substances) or floor wiping.

The robot cleaner 100 may include a cleaner body 110, a suction head 120, a sensor 130, and a dust collector 140. A controller 1800 configured to control the robot cleaner 100 and various components may be accommodated in or mounted to the cleaner body 110. In addition, a wheel 111 configured to drive the robot cleaner 100 may be provided at the cleaner body 110. The robot cleaner 100 may be moved in a forward, backward, leftward, or rightward direction, or may be rotated by the wheel 111.

Referring to FIG. 3, the wheel 111 may include a main wheel 111a and a sub-wheel 111b.

The main wheel 111a may be provided in a plural number such that the main wheels 111a are provided at opposite sides of the cleaner body 110, respectively. The main wheels 111a may be configured to be rotated in a forward direction or in a reverse direction in response to a control signal from the controller. Each of the main wheels 111a may be configured to be independently driven. For example, the main wheels 111a may be driven by different respective motors. Alternatively, the main wheels 111a may be driven by different shafts respectively coupled to a single motor.

The sub-wheel 111b may support the cleaner body 110 along with the main wheels 111a and may assist in the driving of the robot cleaner 100 by the main wheels 111a. The sub-wheel 111b may also be provided at the suction head 120 to be described later.

The controller may control the driving of the wheel 111 such that the robot cleaner 100 autonomously travels the floor.

A battery (not shown) configured to supply power to the robot cleaner 100 may be mounted in the cleaner body 110. The battery may be configured to be rechargeable, and may be detachably mounted to the bottom surface of the cleaner body 110.

As shown in FIG. 1, the suction head 120 may protrude from one side of the cleaner body 110 and may serve to suction air containing dust or to wipe the floor. The one side may be the side of the cleaner body 110 that is oriented in a forward direction F, i.e. the front side of the cleaner body 110.

The drawings illustrate a configuration in which the suction head 120 protrudes from the one side of the cleaner body 110 in the forward direction and in the leftward and rightward directions. In detail, the front end of the suction head 120 may be spaced apart from the one side of the cleaner body 110 in the forward direction, and the left and right ends of the suction head 120 may be spaced apart from the one side of the cleaner body 110 in the leftward and rightward directions, respectively.

The cleaner body 110 may be formed in a circular shape and the left and right sides of the rear end of the suction head 120 may protrude from the cleaner body 110 in the leftward and rightward directions, and thus an empty space, i.e. a gap, may be formed between the cleaner body 110 and the suction head 120. The empty space may be space between the left and right ends of the cleaner body 110 and the left and right ends of the suction head 120 and may have a shape recessed to the inner side of the robot cleaner 100.

When an obstacle is caught in the empty space, the robot cleaner 100 may be caught by the obstacle and become incapable of moving. In order to prevent this, a cover member 129 may be disposed so as to cover at least a portion of the empty space.

The cover member 129 may be provided at the cleaner body 110 or the suction head 120. In this embodiment, the cover member 129 may protrude from each of the left and right sides of the rear end of the suction head 120 and may cover the outer circumferential surface of the cleaner body 110.

The cover member 129 may be disposed so as to fill at least a portion of the empty space, i.e. the empty space between the cleaner body 110 and the suction head 120. Accordingly, an obstacle may be prevented from being caught in the empty space, or even if an obstacle is caught in the empty space, the robot cleaner 100 may easily avoid the obstacle.

The cover member 129 protruding from the suction head 120 may be supported by the outer circumferential surface of the cleaner body 110. When the cover member 129 protrudes from the cleaner body 110, the cover member 129 may be supported by the rear surface portion of the suction head 120. According to the above structure, when the suction head 120 collides with an obstacle and is shocked thereby, a portion of the shock may be transmitted to the cleaner body 110, and thus the shock may be dispersed.

The suction head 120 may be detachably coupled to the cleaner body 110. When the suction head 120 is separated from the cleaner body 110, a mop (not shown) may replace the separated suction head 120, and may be detachably coupled to the cleaner body 110.

Accordingly, when a user intends to remove dust from the floor, the user may install the suction head 120 on the cleaner body 110, and when the user intends to wipe the floor, the user may install the mop on the cleaner body 110.

When the suction head 120 is installed to the cleaner body 110, the installation may be guided by the aforementioned cover member 129. That is, the cover member 129 may be disposed so as to cover the outer circumferential surface of the cleaner body 110, and thus the position of the suction head 120 relative to the cleaner body 110 may be determined.

The suction head 120 may be provided with a caster 123. The caster 123 may be configured to assist driving of the robot cleaner 100 and to support the robot cleaner 100. The sensor 130 may be disposed on the cleaner body 110. As illustrated, the sensor 130 may be disposed on the side of the cleaner body 110 on which the suction head 120 is disposed, i.e. on the front side of the cleaner body 110.

The sensor 130 may be disposed so as to overlap the suction head 120 in the upward-and-downward direction of the cleaner body 110. The sensor 130 may be disposed on the suction head 120 and may detect a forward obstacle, a geographic feature, or the like to prevent the suction head 120 positioned at the foremost side of the robot cleaner 100 from colliding with the obstacle.

The sensor 130 may be configured to additionally perform other sensing functions in addition to such a detection function. For example, the sensor 130 may include a camera 131 for acquiring an image of the surroundings. The camera 131 may include a lens and an image sensor. The camera 131 may convert the image of the surroundings of the cleaner body 110 into an electrical signal that is capable of being processed by the controller 1800, and may transmit an electrical signal corresponding to, for example, an upward image to the controller 1800. The electrical signal corresponding to the upward image may be used for the detection of the position of the cleaner body 110 by the controller 1800.

In addition, the sensor 130 may detect an obstacle, such as a wall, furniture, or a cliff, present on the surface on which the robot cleaner 100 is traveling or in the route along which the robot cleaner 100 is traveling. In addition, the sensor 130 may detect the presence of a docking device for charging the battery. In addition, the sensor 130 may detect information about the ceiling and may map a travel area or a cleaning area of the robot cleaner 100.

The dust collector 140, configured to separate and collect dust from the suctioned air, may be detachably coupled to the cleaner body 110. The dust collector 140 may be provided with a dust collector cover 150 configured to cover the dust collector 140. In one embodiment, the dust collector cover 150 may be rotatably hinged to the cleaner body 110. The dust collector cover 150 may be secured to the dust collector 140 or the cleaner body 110 and may be maintained in the state of covering the top surface of the dust collector 140. In the state of covering the top surface of the dust collector 140, the dust collector cover 150 may prevent the dust collector 140 from being separated from the cleaner body 110.

A portion of the dust collector 140 may be contained in a dust collector container 113, and another portion of the dust collector 140 may protrude in the backward direction of the cleaner body 110 (i.e. a reserve direction R, opposite the forward direction F).

The dust collector 140 may have an entrance formed therein to allow air containing dust to be introduced thereinto and an exit formed therein to allow air from which dust has been removed to be discharged therefrom. When the dust collector 140 is installed in the cleaner body 110, the entrance and the exit may communicate with the cleaner body 110 through an opening 155 formed in an internal wall of the cleaner body 110. Accordingly, an intake flow passage and an exhaust flow passage may be formed in the cleaner body 110.

Owing to this connection relationship, air containing dust introduced through the suction head 120 may be introduced into the dust collector 140 via the intake flow passage inside the cleaner body 110, and air and dust may be separated from each other through a filter or a cyclone of the dust collector 140. Dust may be collected in the dust collector 140, and air may be discharged from the dust collector 140 and may be finally discharged to the outside via the exhaust flow passage inside the cleaner body 110 and an exhaust port 112.

Hereinafter, an embodiment related to components of the robot cleaner 100 will be described with reference to FIG. 4.

The robot cleaner 100 according to an embodiment of the present disclosure may include at least one of a communication interface 1100, an input device 1200, a driver 1300, a sensor 1400, an output device 1500, a power supply 1600, a memory 1700, a controller 1800, a cleaning device 1900, or combinations thereof.

The components shown in FIG. 4 are not essential, and a mobile robot including a greater or smaller number of components than those shown in FIG. 4 may be implemented. In addition, as described above, a plurality of robot cleaners described herein may commonly include only some of the components to be described below. That is, respective mobile robots may include different components from each other.

Hereinafter, the components will be described. First, the power supply 1600 may include a battery that is rechargeable by an external commercial power source and may supply power to the mobile robot. The power supply 1600 may supply driving power to each component included in the mobile robot and may supply operating power required to drive the mobile robot or to perform a specific function.

In this case, the controller 1800 may detect the remaining power of the battery. When the remaining power of the battery is insufficient, the controller 1800 may control the mobile robot to move to a charging station connected to the external commercial power source so that the battery is charged with charging current received from the charging station. The battery may be connected to a battery SoC detection sensor, and information on the remaining power and the state of charge (SoC) of the battery may be transmitted to the controller 1800. The output device 1500 may display the remaining power of the battery under the control of the controller 1800.

The battery may be disposed on the lower side of the center of the mobile robot or may be disposed on one of left and right sides of the mobile robot. In the latter case, the mobile robot may further include a balance weight in order to resolve weight imbalance due to the battery.

The controller 1800 may serve to process information on the basis of artificial-intelligence technology, and may include at least one module performing at least one of learning of information, inference of information, perception of information, or processing of a natural language.

The controller 1800 may perform at least one of learning, inferring, or processing a huge amount of information (big data), such as information stored in the cleaner, environment information about a mobile terminal, and information stored in a communication-capable external storage, using machine-learning technology.

In addition, the controller 1800 may predict (or infer) one or more executable operations of the cleaner using information learned using the machine-learning technology, and may control the cleaner to execute an operation having the highest possibility of realization among the one or more predicted operations. The machine-learning technology is technology for collecting and learning a huge amount of information on the basis of at least one algorithm and determining and predicting information on the basis of the learned information.

Learning of information is an operation of recognizing features, rules, determination criteria, and the like of information, quantifying the relationships between pieces of information, and predicting new data using a quantified pattern.

An algorithm used in the machine-learning technology may be an algorithm based on statistics, and may be, for example, a decision tree using a tree structure form as a prediction model, a neural network imitating a neural network structure and function of living things, generic programming based on an evolution algorithm of living things, clustering distributing observed examples to subsets called communities, a Monte Carlo method calculating a function value as a probability through a randomly extracted random number, and the like.

Deep-learning technology, which is one field of machine-learning technology, is technology of performing at least one of learning, determining, or processing information using a deep neural network (DNN) algorithm. The DNN may have a structure of connecting layers and transmitting data between the layers. Such deep-learning technology may enable a huge amount of information to be learned through the DNN using a graphic processing unit (GPU), optimized for parallel arithmetic calculations.

The controller 1800 may be equipped with a learning engine, which detects features for recognizing a specific object using training data stored in an external server or memory. Here, the features for recognizing an object may include the size, shape, shadow, and the like of the object.

In detail, when the controller 1800 inputs a portion of an image obtained through a camera provided on the cleaner to the learning engine, the learning engine may recognize at least one object or living thing included in the input image. In more detail, the controller 1800 may recognize an artificial mark through any of various methods, among the recognized objects.

Here, the artificial mark may include a figure, a symbol, and the like, which is made artificially. The artificial mark may include at least two line segments. Specifically, the artificial mark may include a combination of two or more straight lines and curved lines. Preferably, the artificial mark may have a polygonal shape, a star shape, a shape corresponding to the specific external appearance of an object, or the like. The size of the artificial mark may be smaller than the size of a wall of a ceiling. Preferably, the size of the artificial mark may be 1% to 5% of the size of a wall or a ceiling.

In detail, the controller 1800 may analyze images collected from the cleaning area, may determine an immovable figure among the collected images, and may specify at least one of the figures determined to be immovable as an artificial mark. The immovable figure may be a figure marked on an immovable object. This process of recognizing a figure marked on an immovable object as an artificial mark may help prevent mismatch between obstacle maps, which may be caused by movement of an artificial mark.

In addition, the controller 1800 may analyze images collected from the cleaning area and may specify at least one of the figures determined to be marked on a wall or a ceiling among the collected images as an artificial mark.

In this manner, when the learning engine is applied to travel of the cleaner, the controller 1800 may recognize whether an obstacle such as the legs of a chair, a fan, or a gap in a balcony having a specific form, which obstructs the travel of the cleaner, is present near the cleaner, thereby increasing the efficiency and reliability of travel of the cleaner.

The aforementioned learning engine may be installed in the controller 1800, or may be installed in an external server. When the learning engine is installed in an external server, the controller 1800 may control the communication interface 1100 to transmit at least one image as an analysis target to the external server.

The external server may input an image received from the cleaner to the learning engine, and may recognize at least one object or living thing included in the corresponding image. In addition, the external server may transmit information related to the recognition result to the cleaner. Here, the information related to the recognition result may include information related to the number of objects included in the image as an analysis target and the name of each object.

The driver 1300 may include a motor, and may drive the motor to rotate left and right main wheels in both directions such that the main body is capable of moving or rotating. In this case, the left and right main wheels may be driven independently. The driver 1300 may enable the main body of the mobile robot to move in the forward, backward, leftward or rightward direction, to move along a curved route, or to rotate in place.

The input device 1200 may receive various control commands regarding the mobile robot from a user. The input device 1200 may include one or more buttons, for example, a verification button, a setting button, and the like. The verification button may be a button for receiving a command for checking detection information, obstacle information, position information, and map information from the user, and the setting button may be a button for receiving, from the user, a command for setting the aforementioned pieces of information.

In addition, the input device 1200 may include an input reset button for canceling a previous user input and receiving new user input, a delete button for deleting previous user input, a button for setting or changing an operation mode, and a button for receiving a command for returning to the charging station.

In addition, the input device 1200 may be implemented as a hard key, a soft key, a touch pad, or the like, and may be installed on an upper portion of the mobile robot. In addition, the input device 1200 may have the form of a touch screen along with the output device 1500.

The output device 1500 may be installed on the upper portion of the mobile robot. The installation position or the installation type of the output device 1500 may vary. For example, the output device 1500 may display the SoC of the battery or the driving mode of the mobile robot on a screen.

In addition, the output device 1500 may output information on the state of the interior of the mobile robot detected by the sensor 1400, for example, the current state of each component included in the mobile robot. In addition, the output device 1500 may display external state information, obstacle information, position information, map information, and the like detected by the sensor 1400, on the screen.

The output device 1500 may be implemented as any one of a light-emitting diode (LED), a liquid crystal display (LCD), a plasma display panel (PDP), and an organic light-emitting diode (OLED).

The output device 1500 may further include a sound output device, which audibly outputs an operation process or an operation result of the mobile robot performed by the controller 1800. For example, the output device 1500 may output a warning sound to the outside in response to a warning signal generated by the controller 1800.

In this case, the sound output device (not shown) may be a device configured to output a sound, for example, a beeper, a speaker, or the like. The output device 1500 may output audio data or message data having a predetermined pattern stored in the memory 1700 through the sound output device.

Thus, the mobile robot according to an embodiment of the present disclosure may output environment information regarding a traveling region on the screen, or may output the same as a sound through the output device 1500. According to another embodiment, the mobile robot may transmit map information or environment information to a terminal device through the communication interface 1100 such that the terminal device outputs a screen or a sound to be output through the output device 1500.

The memory 1700 may store a control program for controlling or driving the mobile robot and data corresponding thereto. The memory 1700 may store audio information, image information, obstacle information, position information, map information, and the like. In addition, the memory 1700 may store information related to a traveling pattern.

As the memory 1700, non-volatile memory may be mainly used. Here, the non-volatile memory (NVM) (or NVRAM) may be a storage device capable of continuously maintaining stored information even though power is not supplied thereto. For example, the memory 1700 may be a ROM, a flash memory, a magnetic computer storage device (e.g. a hard disk, a disk drive, or a magnetic tape), an optical disk drive, a magnetic RAM, a PRAM, or the like.

The sensor 1400 may include at least one of an external signal detection sensor, a front detection sensor, a cliff sensor, a two-dimensional (2D) camera sensor, or a three-dimensional (3D) camera sensor.

The external signal detection sensor may detect an external signal of the mobile robot. The external signal detection sensor may be, for example, an infrared sensor, an ultrasonic sensor, a radio frequency (RF) sensor, or the like.

The mobile robot may verify the position and direction of the charging station upon receiving a guide signal generated by the charging station using the external signal detection sensor. Here, the charging station may transmit the guide signal indicating the direction and the distance such that the mobile robot returns to the charging station. That is, upon receiving the signal transmitted from the charging station, the mobile robot may determine the current position thereof, and may set a movement direction to return to the charging station.

The front detection sensor may be provided in a plural number such that the front detection sensors are installed at regular intervals on the front side of the mobile robot, specifically, along the outer circumference of the side surface of the mobile robot. The front detection sensor may be disposed on at least one side surface of the mobile robot to detect an obstacle ahead. The front detection sensor may detect an object, in particular, an obstacle, present in the movement direction of the mobile robot, and may transmit detection information to the controller 1800. That is, the front detection sensor may detect a protrusion, furnishings, furniture, a wall surface, a wall corner, or the like present in a route along which the mobile robot moves, and may transmit corresponding information to the controller 1800.

The front detection sensor may be, for example, an infrared sensor, an ultrasonic sensor, an RF sensor, a geomagnetic sensor, or the like. The mobile robot may use one type of sensor as the front detection sensor, or may use two or more types of sensors together as the front detection sensor as needed.

For example, in general, the ultrasonic sensor may mainly be used to detect an obstacle in a remote area. The ultrasonic sensor may include a transmitter and a receiver. The controller 1800 may determine whether an obstacle is present based on whether an ultrasonic wave radiated from the transmitter is reflected by an obstacle or the like and received by the receiver, and may calculate the distance to the obstacle using an ultrasonic wave radiation time and an ultrasonic wave reception time.

In addition, the controller 1800 may detect information related to the size of an obstacle by comparing an ultrasonic wave radiated from the transmitter with an ultrasonic wave received by the receiver. For example, when a larger magnitude of ultrasonic wave is received by the receiver, the controller 1800 may determine that the size of the obstacle is larger.

In one embodiment, a plurality of ultrasonic sensors (e.g. five ultrasonic sensors) may be installed on the outer circumferential surface of the front side of the mobile robot. In this case, preferably, the transmitters and the receivers of the ultrasonic sensors may be installed alternatingly on the front surface of the mobile robot.

That is, the transmitters may be disposed so as to be spaced apart from each other in the leftward-and-rightward direction with respect to the center of the front surface of the main body of the mobile robot, and one or two or more transmitters may be provided between the receivers to form a reception region of an ultrasonic signal reflected from the obstacle or the like. Due to this disposition, a reception region may be expanded while reducing the number of sensors. The angle at which the ultrasonic wave is radiated may be maintained at an angle within a range within which other signals are not affected, thereby preventing a crosstalk phenomenon. In addition, the reception sensitivities of the receivers may be set to be different from each other.

In addition, the ultrasonic sensors may be installed so as to be oriented upwards at a predetermined angle such that the ultrasonic waves radiated from the ultrasonic sensors are output upwards. In this case, in order to prevent the ultrasonic waves from being radiated downwards, a blocking member may be further provided.

As mentioned above, two or more types of sensors may be used together as the front detection sensors. In this case, one or more types of sensors among an infrared sensor, an ultrasonic sensor, and an RF sensor may be used as the front detection sensors.

In one example, the front detection sensor may include an infrared sensor as a different type of sensor, in addition to the ultrasonic sensor. The infrared sensor may be installed on the outer circumferential surface of the mobile robot together with the ultrasonic sensor. The infrared sensor may also detect an obstacle present ahead of or beside the mobile robot and may transmit corresponding obstacle information to the controller 1800. That is, the infrared sensor may detect a protrusion, furnishings, furniture, a wall surface, a wall corner, or the like present in a route along which the mobile robot moves, and may transmit corresponding information to the controller 1800. Thus, the mobile robot may move within a cleaning area without colliding with an obstacle.

Various types of optical sensors may be mainly used as the cliff sensor. The cliff sensor may detect an obstacle on the floor supporting the main body of the mobile robot. The cliff sensor may be installed on the rear surface of the mobile robot. However, the cliff sensor may be installed at different positions depending on the type of the mobile robot.

The cliff sensor may be disposed on the rear surface of the mobile robot to detect an obstacle on the floor. The cliff sensor may be an infrared sensor including a light transmitter and a light receiver, an ultrasonic sensor, an RF sensor, a position sensitive detection (PSD) sensor, or the like, like the obstacle detection sensor.

In one example, any one of cliff sensors may be installed on the front side of the mobile robot, and the other two cliff sensors may be installed on a relatively rear side of the mobile robot. For example, the cliff sensor may be a PSD sensor, or may include a plurality of different types of sensors.

The PSD sensor detects the positions of the short and long distances of incident light with a single p-n junction using the surface resistance of a semiconductor. The PSD sensor may be classified into a one-dimensional (1D) PSD sensor that detects light on a single axis and a 2D PSD sensor that detects the position of light on a plane. Both the 1D PSD sensor and the 2D PSD sensor may have a pin photodiode structure. The PSD sensor is a type of infrared sensor that transmits an infrared ray to an obstacle and measures the angle between the infrared ray transmitted to the obstacle and the infrared ray returning thereto after being reflected from the obstacle, thus measuring the distance to the obstacle. That is, the PSD sensor calculates the distance to an obstacle using triangulation.

The PSD sensor may include a light transmitter configured to emit an infrared ray to an obstacle and a light receiver configured to receive an infrared ray returning thereto after being reflected from the obstacle. In general, the PSD sensor is formed as a module. In the case in which an obstacle is detected using the PSD sensor, a consistent measurement value may be obtained regardless of differences in reflectivity or the color of obstacles.

The cleaning device 1900 may clean the designated cleaning area in response to a control command transmitted from the controller 1800. The cleaning device 1900 may scatter surrounding dust through a brush (not shown) that scatters dust in the designated cleaning area and may then drive a suction fan and a suction motor to suction the scattered dust. In addition, the cleaning device 1900 may mop the designated cleaning area according to the replacement of the cleaning tool.

The controller 1800 may measure the angle between an infrared ray radiated toward the floor from the cliff sensor and an infrared ray received by the cliff sensor after being reflected from an obstacle to detect a cliff, and may analyze the depth of the cliff.

The controller 1800 may determine the state of a cliff detected by the cliff sensor and may determine whether the mobile robot is capable of passing over the cliff based on the result of determining the state of the cliff. In one example, the controller 1800 may determine the presence or absence of a cliff and the depth of a cliff using the cliff sensor and may allow the mobile robot to pass over the cliff only when the cliff sensor senses a reflection signal. In another example, the controller 1800 may determine whether the mobile robot is being lifted using the cliff sensor.

The 2D camera sensor may be provided on one surface of the mobile robot and may obtain image information related to the surroundings of the main body during movement. An optical flow sensor may convert an image of the lower side input from an image sensor provided therein to generate image data in a predetermined format. The generated image data may be stored in the memory 1700.

In addition, one or more light sources may be installed adjacent to the optical flow sensor. The one or more light sources may radiate light to a predetermined region of the floor that is photographed by the image sensor. When the mobile robot moves a specific region on the floor, if the floor is flat, a uniform distance may be maintained between the image sensor and the floor.

On the other hand, in the case in which the mobile robot moves on a floor that is uneven, the image sensor may become distant from the floor by a predetermined distance or more due to depressions and protrusions in the floor and obstacles on the floor. In this case, the controller 1800 may control the one or more light sources to adjust the amount of light radiated therefrom. The light sources may be light-emitting devices, for example, light-emitting diodes (LEDs), which are capable of adjusting the amount of light.

The controller 1800 may detect the position of the mobile robot using the optical flow sensor regardless of slippage of the mobile robot. The controller 1800 may compare and analyze image data captured by the optical flow sensor over time to calculate a movement distance and a movement direction, and may calculate the position of the mobile robot based thereon. By using the image information regarding the lower side of the mobile robot using the optical flow sensor, the controller 1800 may perform correction resistant to slippage with respect to the position of the mobile robot, which is calculated by other devices.

The 3D camera sensor may be attached to one surface or a portion of the main body of the mobile robot, and may generate 3D coordinate information related to the surroundings of the main body. For example, the 3D camera sensor may be a 3D depth camera configured to calculate the distance between the mobile robot and a target to be photographed.

In detail, the 3D camera sensor may capture a 2D image related to the surroundings of the main body and may generate a plurality of pieces of 3D coordinate information corresponding to the captured 2D image.

In one embodiment, the 3D camera sensor may be of a stereovision type. That is, the 3D camera sensor may include two or more typical cameras obtaining 2D images and may combine two or more images obtained by the two or more cameras to generate 3D coordinate information.

In detail, the 3D camera sensor according to the embodiment may include a first pattern transmitter configured to radiate light having a first pattern downwards toward a region ahead of the main body, a second pattern transmitter configured to radiate light having a second pattern upwards toward a region ahead of the main body, and an image obtainer configured to obtain a forward image of the main body. Accordingly, the image obtainer may obtain an image of a region on which the light having a first pattern and the light having a second pattern are incident.

In another embodiment, the 3D camera sensor may include a single camera and an infrared pattern transmitter configured to radiate an infrared pattern, and may measure the distance between the 3D camera sensor and a target to be photographed by capturing a shape in which an infrared pattern radiated from the infrared pattern transmitter is projected onto the target to be photographed. This 3D camera sensor may be an infrared-type 3D camera sensor.

In still another embodiment, the 3D camera sensor may include a single camera and a light emitter configured to emit a laser beam, and may measure the distance between the 3D camera sensor and a target to be photographed by receiving a portion of the laser beam reflected from the target to be photographed after being emitted from the light emitter and analyzing the received laser beam. This 3D camera sensor may be a time-of-flight (ToF)-type 3D camera sensor.

In detail, the above 3D camera sensor may be configured to radiate a laser beam in a form extending in at least one direction. In one example, the 3D camera sensor may include first and second lasers such that the first laser radiates linear laser beams intersecting each other and the second laser radiates a single linear laser beam. According to this, the lowermost laser beam may be used to detect an obstacle located at a lower region, the uppermost laser beam may be used to detect an obstacle located at an upper region, and the intermediate laser beam between the lowermost laser beam and the uppermost laser beam may be used to detect an obstacle located at an intermediate region.

The sensor 1400 may collect information on an artificial mark within a cleaning area. In detail, the 2D or 3D camera sensor may collect an image including information on an artificial mark within a cleaning area.

The communication interface 1100 may be connected to a terminal device and/or another device present within a specific region (which will be interchangeably used with the term “home appliance” in this specification) in any one of wired, wireless, and satellite communication schemes to exchange signals and data therewith.

The communication interface 1100 may transmit and receive data to and from another device present within a specific region. Here, the other device may be any device, as long as it is capable of transmitting and receiving data over a network. For example, the other device may be an air conditioner, a heater, an air purifier, a lamp, a TV, a vehicle, or the like. Alternatively, the other device may be a device for controlling a door, a window, a water valve, a gas valve, or the like. Alternatively, the other device may be a sensor for sensing temperature, humidity, atmospheric pressure, gas, or the like.

In addition, the communication interface 1100 may communicate with another robot cleaner 100 present within a specific region or within a predetermined range.

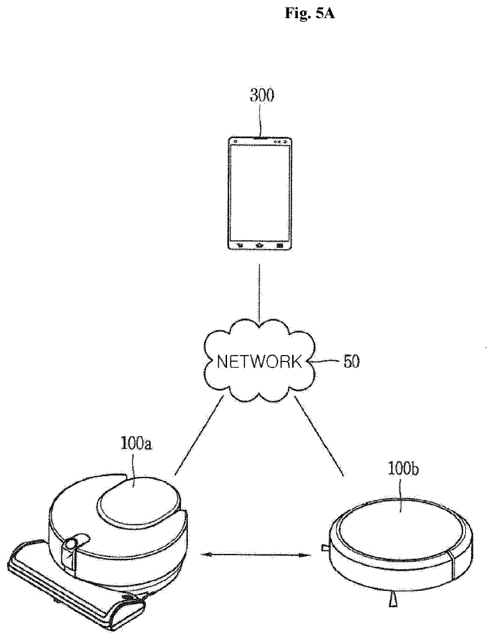

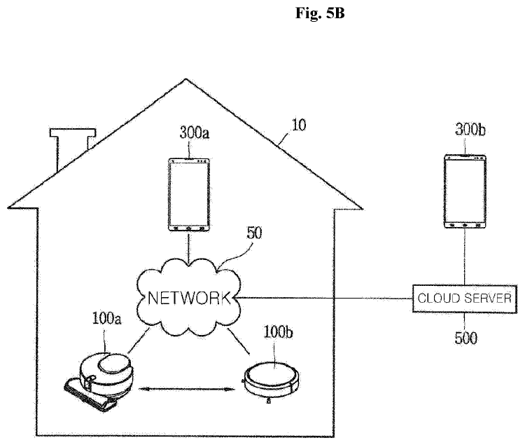

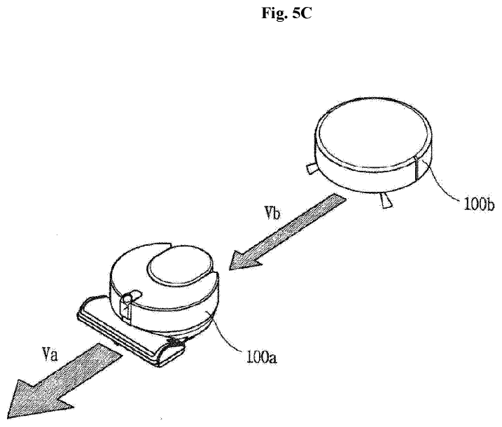

Referring to FIGS. 5A and 5B, a first mobile robot 100a and a second mobile robot 100b, which autonomously travel, may exchange data with each other through a network communication device 50. In addition, the first mobile robot 100a and/or the second mobile robot 100b, which autonomously travel, may perform cleaning-related operations or operations corresponding thereto in response to a control command received from a terminal 300 through the network communication device 50 or another communication scheme.

Although not shown in the drawings, a plurality of mobile robots 100a and 100b, which autonomously travel, may communicate with the terminal 300 through the first network communication and may communicate with each other through the second network communication.

Here, the network communication device 50 may be a short-range communication device using at least one wireless communication technology selected from among Wireless LAN (WLAN), Wireless Personal Area Network (WPAN), Wireless-Fidelity (Wi-Fi), Wireless-Fidelity (Wi-Fi) Direct, Digital Living Network Alliance (DLNA), Wireless Broadband (WiBro), World Interoperability for Microwave Access (WiMAX), ZigBee, Z-wave, Bluetooth, Radio Frequency Identification (RFID), Infrared Data Association (IrDA), Ultra-Wide Band (UWB), and Wireless Universal Serial Bus (Wireless USB).

The illustrated network communication device 50 may vary depending on the communication scheme through which the mobile robots communicate with each other.

Referring to FIG. 5A, the first mobile robot 100a and/or the second mobile robot 100b, which autonomously travel, may transmit information sensed by the sensor thereof to the terminal 300 through the network communication device 50. The terminal 300 may transmit a control command generated based on the received information to the first mobile robot 100a and/or the second mobile robot 100b through the network communication device 50.

In addition, referring to FIG. 5A, the communication interface of the first mobile robot 100a and the communication interface of the second mobile robot 100b may directly or indirectly wirelessly communicate with each other through a router (not shown), thereby exchanging information regarding the traveling states and positions thereof.

In one example, the second mobile robot 100b may perform traveling and cleaning operations in response to a control command received from the first mobile robot 100a. In this case, it can be said that the first mobile robot 100a serves as a master and the second mobile robot 100b serves as a slave.

Alternatively, it can be said that the second mobile robot 100b follows the first mobile robot 100a. Alternatively, in some cases, it can be said that the first mobile robot 100a and the second mobile robot 100b cooperate with each other.

Hereinafter, a system including a plurality of mobile robots 100a and 100b configured to autonomously travel according to an embodiment of the present disclosure will be described with reference to FIG. 5B.

Referring to FIG. 5B, a cleaning system according to an embodiment of the present disclosure may include a plurality of mobile robots 100a and 100b, which autonomously travel, a network communication device 50, a server 500, and a plurality of terminals 300a and 300b.

Among them, the mobile robots 100a and 100b, the network communication device 50, and at least one terminal 300a may be disposed in a building 10, and the other terminal 300b and the server 500 may be disposed outside the building 10.

Each of the mobile robots 100a and 100b may be a cleaner that is capable of autonomously performing cleaning while autonomously traveling. Each of the mobile robots 100a and 100b may include a communication interface 1100 in addition to components for performing the traveling function and the cleaning function.

The mobile robots 100a and 100b, the server 500, and the terminals 300a and 300b may be connected to each other through the network communication device 50 and may exchange data with each other. To this end, although not illustrated, a wireless router such as an access point (AP) device may be further provided. In this case, the terminal 300a located in the internal network may be connected to at least one of the mobile robots 100a and 100b through the AP device and may monitor and remotely control the cleaner. In addition, the terminal 300b located in the external network may also be connected to at least one of the mobile robots 100a and 100b through the AP device and may monitor and remotely control the cleaner.

The server 500 may be directly wirelessly connected to the mobile terminal 300b. Alternatively, the server 500 may be connected to at least one of the mobile robots 100a and 100b without using the mobile terminal 300b.

The server 500 may include a processor capable of executing a program and may further include various algorithms. In one example, the server 500 may include an algorithm associated with the performance of machine learning and/or data mining.

In another example, the server 500 may include a voice recognition algorithm. In this case, upon receiving voice data, the server 500 may convert the received voice data into data in a text format and may output the data in a text format.

The server 500 may store firmware information and traveling information (e.g. course information, etc.) about the mobile robots 100a and 100b and may register product information about the mobile robots 100a and 100b. For example, the server 500 may be a server administered by a cleaner manufacturer or a server administered by a publicly accessible application store operator.

In still another example, the server 500 may be a home server that is provided in the internal network 10 to store state information about home appliances or store content shared between the home appliances. When the server 500 is a home server, the server 500 may store information related to foreign substances, for example, images of foreign substances and the like.

The mobile robots 100a and 100b may be directly wirelessly connected to each other through ZigBee, Z-wave, Bluetooth, Ultra-Wide Band, or the like. In this case, the mobile robots 100a and 100b may exchange position information and traveling information thereof with each other.

In this case, any one of the mobile robots 100a and 100b may serve as a master mobile robot (e.g. 100a), and the other one may serve as a slave mobile robot (e.g. 100b). For example, the first mobile robot 100a may be a dry-type cleaner configured to suction dust from the floor to be cleaned, and the second mobile robot 100b may be a wet-type cleaner configured to mop the floor that has been cleaned by the first mobile robot 100a.

In addition, the first mobile robot 100a and the second mobile robot 100b may have different structures and specifications from each other. In this case, the first mobile robot 100a may control the traveling operation and the cleaning operation of the second mobile robot 100b. In addition, the second mobile robot 100b may perform the traveling operation and the cleaning operation while following the first mobile robot 100a. Here, the operation in which the second mobile robot 100b follows the first mobile robot 100a may mean the operation in which the second mobile robot 100b performs cleaning while traveling after the first mobile robot 100a at an appropriate distance away from the first mobile robot 100a.

Referring to FIG. 5C, the first mobile robot 100a may control the second mobile robot 100b to follow the first mobile robot 100a.

To this end, the first mobile robot 100a and the second mobile robot 100b need to be located within a specific region within which communication therebetween is possible, and the second mobile robot 100b needs to perceive at least the relative position of the first mobile robot 100a.

In one example, the communication interface of the first mobile robot 100a and the communication interface of the second mobile robot 100b may exchange IR signals, ultrasonic signals, carrier frequencies, impulse signals, and the like with each other, and may analyze the same using triangulation to calculate the displacement of the first mobile robot 100a and the second mobile robot 100b, thereby perceiving the positions of the first mobile robot 100a and the second mobile robot 100b relative to each other.

However, the position perception through signal exchange may be realized only when the first mobile robot 100a and the second mobile robot 100b are provided with respective position sensors or are sufficiently close to each other. Therefore, the present disclosure proposes a method of enabling any one of the first mobile robot 100a and the second mobile robot 100b to easily perceive the relative position of the other one within a designated space without separate position sensors and regardless of the distance between the first mobile robot 100a and the second mobile robot 100b.

As such, when the positions of the first mobile robot 100a and the second mobile robot 100b relative to each other are perceived, the second mobile robot 100b may be controlled on the basis of the map information stored in the first mobile robot 100a or the map information stored in the server or the terminal. In addition, the second mobile robot 100b may share the obstacle information sensed by the first mobile robot 100a. In addition, the second mobile robot 100b may operate in response to a control command (a command for controlling travel, for example, a traveling direction, a traveling speed, stop, etc.) received from the first mobile robot 100a.

In detail, the second mobile robot 100b may perform cleaning while traveling along the route along which the first mobile robot 100a has traveled. However, the current direction in which the first mobile robot 100a is traveling and the current direction in which the second mobile robot 100b is traveling are not always the same. This is because, after the first mobile robot 100a moves or turns in the forward, backward, leftward, or rightward direction, the second mobile robot 100b moves or turns in the forward, backward, leftward, or rightward direction a predetermined amount of time later.

In addition, the speed Va at which the first mobile robot 100a travels and the speed Vb at which the second mobile robot 100b travels may be different from each other. The first mobile robot 100a may control the traveling speed Vb of the second mobile robot 100b in consideration of the distance within which communication between the first mobile robot 100a and the second mobile robot 100b is possible.

In one example, when the first mobile robot 100a and the second mobile robot 100b are spaced apart from each other by a predetermined distance or more, the first mobile robot 100a may control the traveling speed Vb of the second mobile robot 100b to be higher than before. In addition, when the first mobile robot 100a and the second mobile robot 100b are close to each other by a predetermined distance or less, the first mobile robot 100a may control the traveling speed Vb of the second mobile robot 100b to be lower than before, or may control the second mobile robot 100b to stop for a predetermined amount of time. Through this, the second mobile robot 100b may perform cleaning while continuously following the first mobile robot 100a.

In addition, although not illustrated, the first mobile robot 100a and the second mobile robot 100b may operate so as to cooperatively clean their own designated spaces. To this end, each of the first mobile robot 100a and the second mobile robot 100b may have an obstacle map, which indicates an obstacle within the designated space that has been cleaned at least once by the corresponding mobile robot and in which the position coordinates of the corresponding mobile robot are marked.

The obstacle map may include information about the region in a specific space (e.g. the shape of the region, the position of a wall, the height of a floor, the position of a door/doorsill, etc.), information about the position of the cleaner, the information about the position of the charging station, and information about an obstacle present within the specific space (e.g. the position of an obstacle, the size of an obstacle, etc.). Here, the obstacle may include a fixed obstacle that protrudes from the floor in the cleaning area and obstructs the travel of the cleaner, such as a wall, furniture, or furnishings, a movable obstacle that is moving, and a cliff.

The obstacle map included in the first mobile robot 100a and the obstacle map included in the second mobile robot 100b may be different from each other. For example, when the first mobile robot 100a and the second mobile robot 100b are of different types from each other or include different types of obstacle detection sensors from each other (e.g. an ultrasonic sensor, a laser sensor, a radar sensor, an infrared sensor, a bumper, etc.), different obstacle maps may be generated, even though they are generated with respect to the same space.

The memory 1700 of each of the first mobile robot 100a and the second mobile robot 100b may store an obstacle map, which has been generated in advance with respect to a designated space before performing cooperative cleaning, and map data associated therewith.

Each obstacle map may be implemented in the form of a 2D or 3D image or a grid map of the designated space. In addition, each obstacle map may include information about at least one obstacle (e.g. position information and size information about a table, a wall, a doorsill, or the like) and information about the position of the corresponding mobile robot (i.e. the first mobile robot 100a or the second mobile robot 100b).

In addition, each obstacle map may be generated so as to have the same shape as the designated actual space, and may be generated in the same scale as the actual space based on the values measured in the floor plan.

The first mobile robot 100a and the second mobile robot 100b may independently travel and perform cleaning in the respectively designated spaces. However, when the first mobile robot 100a and the second mobile robot 100b separately perform cleaning according to their own scenarios, rather than performing cooperative cleaning, the route along which the first mobile robot 100a travels and the route along which the second mobile robot 100b travels may overlap each other, or various other problems may occur. In this case, it is difficult to accomplish efficient cleaning using a plurality of mobile robots.

Therefore, according to the present disclosure, each of the plurality of mobile robots is configured to perceive the relative position of the other mobile robot within a designated space without a position sensor in order to perform cooperative/following cleaning operation.

In detail, according to the present disclosure, the first mobile robot 100a may communicate with the second mobile robot 100b and may receive an obstacle map, in which the position of the second mobile robot 100b and an artificial mark are marked, from the second mobile robot 100b. Thereafter, the first mobile robot 100a may standardize the coordinate system of the received obstacle map with the coordinate system of the obstacle map thereof through calibration based on the artificial mark in the obstacle map thereof. Thereafter, the first mobile robot 100a may perceive the relative position of the second mobile robot 100b using the obstacle map of the second mobile robot 100b, the coordinate system of which has been standardized. That is, according to the present disclosure, even if the coordinate systems of the obstacle maps of the first and second mobile robots 100a and 100b are different from each other due to the use of different types of obstacle detection sensors, even if the first mobile robot 100a and the second mobile robot 100b are spaced apart from each other to an extent to which exchange of a short-range wireless signal therebetween is impossible, or even if the first mobile robot 100a and the second mobile robot 100b are not provided with position sensors, each of the first mobile robot 100a and the second mobile robot 100b may perceive the relative position of the other mobile robot within the same space, as long as the first mobile robot 100a and the second mobile robot 100b have obstacle maps with respect to the same space.

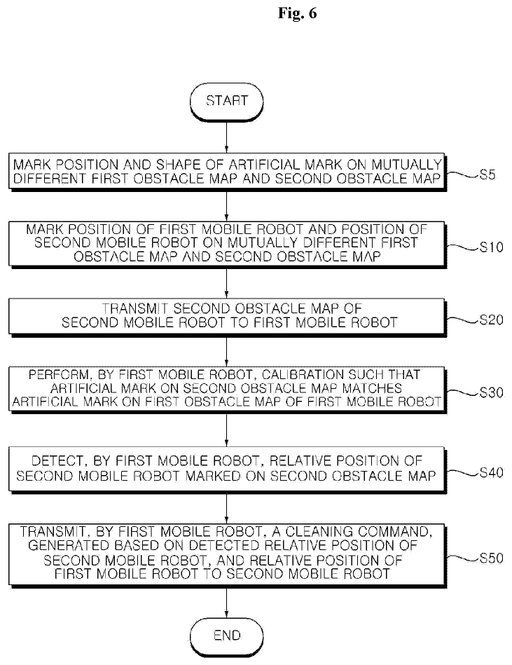

Hereinafter, a method in which a plurality of mobile robots detects the positions thereof relative to each other within a designated space according to the present disclosure will be described in detail with reference to FIG. 6.

Referring to FIG. 6, the present disclosure includes steps of generating a first obstacle map Map 1 and a second obstacle map Map 2 (S5 and S10).

The steps S5 and S10 of generating the first obstacle map Map 1 and the second obstacle map Map 2 may include a step of marking the position and shape of an artificial mark on the first obstacle map Map 1 and the second obstacle map Map 2, which are different from each other (S5), and a step of marking the position of the first mobile robot 100a and the position of the second mobile robot 100b on the first obstacle map Map 1 and the second obstacle map Map 2, which are different from each other (S10).

Here, the first obstacle map Map 1 and the second obstacle map Map 2 may be mutually different obstacle maps generated in advance with respect to the same cleaning space.

Specifically, the first obstacle map Map 1 may be a grid map or an image map that the first mobile robot 100a generated earlier based on information collected by the obstacle sensor while traveling in a specific cleaning space, and the second obstacle map Map 2 may be a grid map or an image map that the second mobile robot 100b generated earlier based on information collected by the obstacle sensor while traveling in the same specific cleaning space.

Here, the grid map may be generated based on a plan view of the cleaning space obtained from the external server, a designated interne site, or the like. The image map may be generated by connecting and combining images obtained through cameras installed to the cleaners.

The first obstacle map Map 1 and the second obstacle map Map 2 may be stored in the memory of the first mobile robot 100a and the memory of the second mobile robot 100b, respectively, or may be stored in a controller for controlling the operation of the first and second mobile robots 100a and 100b or in a server communicating with the controller.

In addition, the position of the first mobile robot 100a marked on the first obstacle map Map 1 and the position of the second mobile robot 100b marked on the second obstacle map Map 2 may be determined on the basis of the initial position at which the charging station is located before the first and second mobile robots 100a and 110b travel.

Subsequently, a step of transmitting the second obstacle map Map 2 of the second mobile robot 100b to the first mobile robot 100a (S20) may be performed. To this end, the first mobile robot 100a and the second mobile robot 100b may be connected to each other through network communication such as Wi-Fi or Bluetooth communication. In this case, the transmission of the second obstacle map Map 2 may be performed in response to the request of the first mobile robot (100a). Alternatively, the second obstacle map of the second mobile robot 100b may be transmitted to the first mobile robot 100a before the first mobile robot 100a and the second mobile robot 100b travel.

The first mobile robot 100a, which receives the second obstacle map Map 2, may perform calibration such that the artificial mark on the second obstacle map Map 2 matches the artificial mark on the first obstacle map Map 1 of the first mobile robot 100a (S30).

Here, the operation of performing calibration such that the artificial mark on the second obstacle map Map 2 matches the artificial mark on the first obstacle map Map 1 may be the operation of transforming the coordinate system of the second obstacle map Map 2 so as to match the coordinate system of the first obstacle map Map 1 so that the first mobile robot 100a and the second mobile robot 100b recognize the positions thereof relative to each other in the same coordinate system.

First, calibration may be performed on the received second obstacle map Map 2 on the basis of the artificial mark on the first obstacle map Map 1. Specifically, upon receiving the second obstacle map Map 2 for the cleaning area from the second mobile robot 100b, the controller 1800 may perform calibration on the received second obstacle map Map 2 on the basis of the artificial mark on the stored first obstacle map Map 1.

According to the above-described criterion, the controller 1800 may extract a first artificial mark F1 on the first obstacle map Map 1 that corresponds to a second artificial mark F2 on the received second obstacle map Map 2. The first mobile robot 100a may extract a first artificial mark F1 having the same shape as the second artificial mark F2 from the first obstacle map Map 1. In this case, it is preferable that the first artificial mark F1 and the second artificial mark F2 be provided in a plural number for accurate calibration.

The first mobile robot 100a (or the controller 1800) may perform calibration on the second obstacle map Map 2 by calculating a conversion value for scaling, rotating, or moving at least one of the first obstacle map Map 1 or the second obstacle map Map 2 such that the first artificial mark F1 on the first obstacle map Map 1 and the second artificial mark F2 on the second obstacle map Map 2 match each other.

In detail, the first mobile robot 100a (or the controller 1800) may perform calibration on the second obstacle map Map 2 by calculating a conversion value for scaling, rotating, or moving at least one of the first obstacle map Map 1 or the second obstacle map Map 2 such that the position and shape of the first artificial mark F1 on the first obstacle map Map 1 and the position and shape of the second artificial mark F2 on the second obstacle map Map 2 match each other.

In another example, the first mobile robot 100a (or the controller 1800) may perform calibration on the second obstacle map Map 2 by calculating a conversion value for scaling, rotating, or moving at least one of the first obstacle map Map 1 or the second obstacle map Map 2 such that a plurality of first artificial marks F1 on the first obstacle map Map 1 and a plurality of second artificial marks F2 on the second obstacle map Map 2 match each other.

First, X-Y coordinates may be formed using the center position of the first obstacle map Map 1 as the origin. Here, the center position may be a point that corresponds to the center of gravity of the first obstacle map Map 1 or a specific point (e.g. the position of the charging station) that is fixedly present in the corresponding space. Subsequently, the coordinate values *?* of objects (e.g. grid squares) constituting the second obstacle map Map 2 may be converted into X-Y coordinates, the converted Y-axis coordinate values *?* of the objects may be decreased/increased at a predetermined ratio, and the converted X-axis coordinate values *?* of the objects may be put into a predetermined X-axis coordinate value conversion function such that the scaling thereof is converted. Subsequently, the center of the X-Y axis may undergo parallel translation and/or rotary translation, and a conversion value corresponding thereto may be applied such that the second artificial mark F2 (the position and shape of the second artificial mark F2) on the second obstacle map Map 2, the scaling of which has been converted, completely overlaps the first artificial mark F1 (the position and shape of the first artificial mark F1) on the first obstacle map Map 1, thereby completing the calibration.

In another example, the center of the X-Y axis may undergo parallel translation and/or rotary translation, and a conversion value corresponding thereto may be applied such that the second artificial mark F2 (the position and shape of the second artificial mark F2) on the second obstacle map Map 2, the scaling of which is not converted, completely overlaps the first artificial mark F1 (the position and shape of the first artificial mark F1) on the first obstacle map Map 1, and the respective obstacle maps may be scaled such that the second artificial mark F2 and the first artificial mark F1 completely overlap each other, thereby completing the calibration.

In still another example, calibration may be performed on the basis of a predetermined map or a normal coordinate system, rather than being performed on the basis of the first obstacle map Map 1. In this case, calibration may be performed on the first obstacle map Map 1 as well as the second obstacle map Map 2.

As such, when the coordinate system of the first obstacle map Map 1 and the coordinate system of the second obstacle map Map 2 are matched with each other through the calibration, the first mobile robot 100a may detect the relative position of the second mobile robot 100b marked on the second obstacle map Map 2 (S40).

In one example, the coordinates of the relative position of the second mobile robot 100b may be marked on the calibrated second obstacle map Map 2. To this end, an image of the second obstacle map Map 2, on which the positions of the first mobile robot 100a and the second mobile robot 100b relative to each other are marked, may be output on the screen of the mobile terminal 300a, which communicates with the first mobile robot 100a and/or the second mobile robot 100b.

Subsequently, the first mobile robot 100a may transmit a cleaning command, which is generated based on the detected relative position of the second mobile robot 100b, and information about the position of the first mobile robot 100a relative to the second mobile robot 100b (S50).

Here, the information about the relative position of the first mobile robot 100a may be recognized on the basis of the position coordinates of the second mobile robot 100b when the first obstacle map Map 1 and the second obstacle map Map 2 completely overlap each other through the calibration.

In addition, the cleaning command may be a cleaning command for a specific region that is selected based on information about the position of the first mobile robot 100a, information about an obstacle on the first or second obstacle map Map 1 or Map 2, and information about the position of the second mobile robot 100b, or may be a cleaning command for instructing the second mobile robot 100b to travel along the route along which the first mobile robot 100a has traveled.

In one embodiment, the first mobile robot 100a may transmit a conversion value corresponding to the above-described calibration to the second mobile robot 100b, thereby enabling the second mobile robot 100b to recognize the relative position of the first mobile robot 100a as well as the position of the second mobile robot 100b in real time using the unified coordinate system.

In addition, in the embodiment, when the second obstacle map Map 2 is calibrated, the first mobile robot 100a may recognize the position coordinates of an obstacle marked only on the first obstacle map Map 1 on the basis of the position coordinates of the second mobile robot 100b, and may transmit the recognized position coordinates of the obstacle to the second mobile robot 100b. Accordingly, for example, when the obstacle sensor of the first mobile robot 100a has higher performance than the obstacle sensor of the second mobile robot 100b, the second mobile robot 100b may more easily and rapidly receive information about undetected obstacles within a designated cleaning area. Further, the second obstacle map Map 2 of the second mobile robot 100b may be easily and rapidly updated.

In addition, according to the present disclosure, in the case in which the first mobile robot 100a and the second mobile robot 100b perform cooperative cleaning in a plurality of regions, into which a designated space is divided, it may be sufficient for the first mobile robot 100a and the second mobile robot 100b to recognize the positions thereof relative to each other only once in order to share a cooperation scenario. Alternatively, the first mobile robot 100a and the second mobile robot 100b may be controlled to detect the positions thereof relative to each other every time any one of the plurality of divided regions is completely cleaned.

As described above, according to the present disclosure, when a plurality of mobile robots cleans a designated space in a following cleaning manner or in a cooperative cleaning manner, they may easily detect the positions thereof relative to each other within the designated space, even without a position sensor.

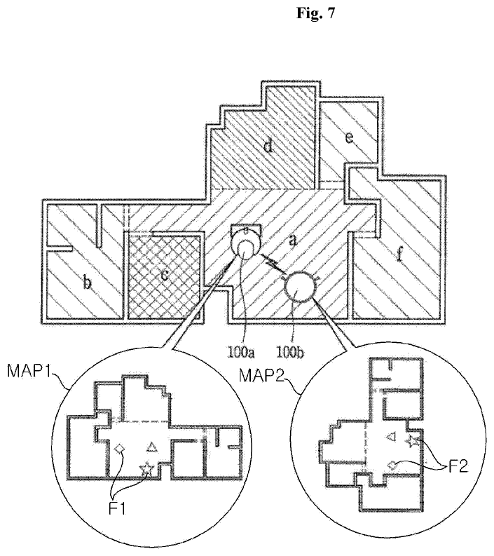

Hereinafter, FIG. 7 shows an example in which a plurality of mobile robots performs cleaning using mutually different obstacle maps, on which the positions thereof are respectively marked, while communicating with each other.

Referring to FIG. 7, a designated cleaning space may be divided/partitioned into a plurality of regions a to f for cooperative cleaning when viewed in plan. Although FIG. 7 illustrates that the first mobile robot 100a and the second mobile robot 100b are located in the same region a, the present disclosure is not limited thereto. The first mobile robot 100a and the second mobile robot 100b may be located anywhere within the designated cleaning space.

Mutually different obstacle maps Map 1 and Map 2 may be generated in advance and stored in the first mobile robot 100a and the second mobile robot 100b, respectively. In this case, the first obstacle map Map 1 and the second obstacle map Map 2 may be mutually different maps that are generated by sensing the same cleaning space using mutually different sensors. For example, the first obstacle map Map 1 may be an obstacle map using a red-green-blue-depth (RGBD) sensor, and the second obstacle map Map 2 may be an obstacle map using an ultrasonic sensor or a laser sensor.

When the coordinate system of the first obstacle map Map 1 and the coordinate system of the second obstacle map Map 2 are matched with each other according to the above-described calibration process, a cooperation scenario may be generated based on the positions of the first and second mobile robots relative to each other.

For example, as shown in FIG. 7, in the case in which the cleaning space is divided into a first group including regions b and c, a second group including regions e and f, and a third group including regions a and d, a cooperation scenario may be generated such that the first mobile robot 100a cleans the regions b and c of the first group, in which the first mobile robot 100a is expected to perform cleaning while traveling the shortest distance from the current position thereof, the second mobile robot 100b cleans the regions e and f of the second group simultaneously therewith, and the first mobile robot 100a and the second mobile robot 100b cooperatively clean the regions a and d of the third group upon finishing cleaning the their own cleaning regions. In the case in which a time point at which the regions b and c of the first group are completely cleaned and a time point at which the regions e and f of the second group are completely cleaned are different from each other, an existing cooperation scenario may be modified or changed on the basis of the earlier cleaning completion time point in order to shorten the cleaning time.

In one example, among the plurality of regions corresponding to the obstacle maps, only some necessary regions may be selectively calibrated. For example, the coordinate systems of the obstacle maps may be unified with respect to only the remaining regions, excluding the regions that have been completely cleaned, thereby reducing the complexity of calculating the conversion values corresponding to scaling, rotation, and translation.

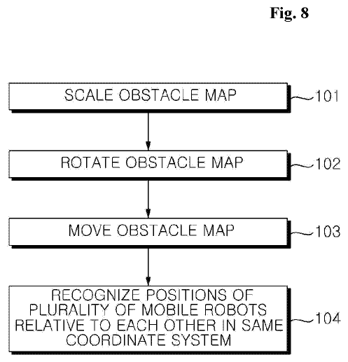

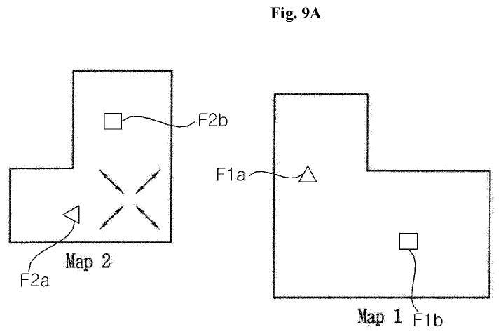

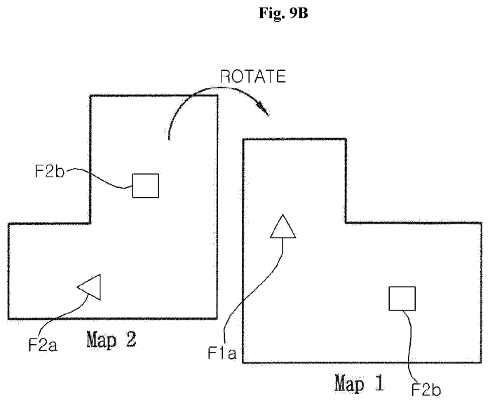

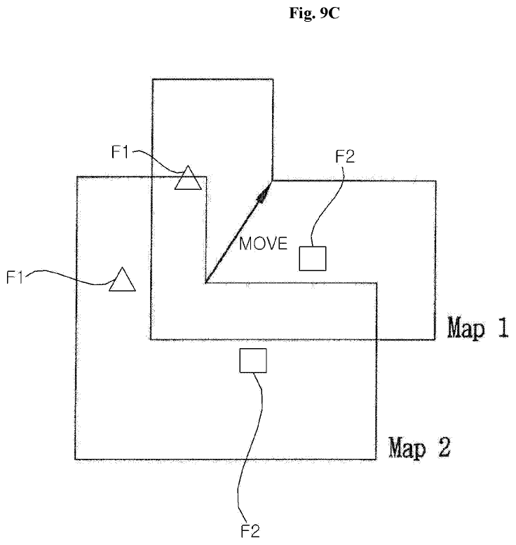

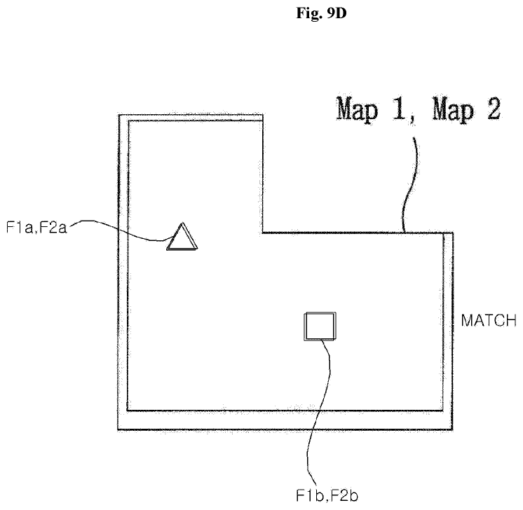

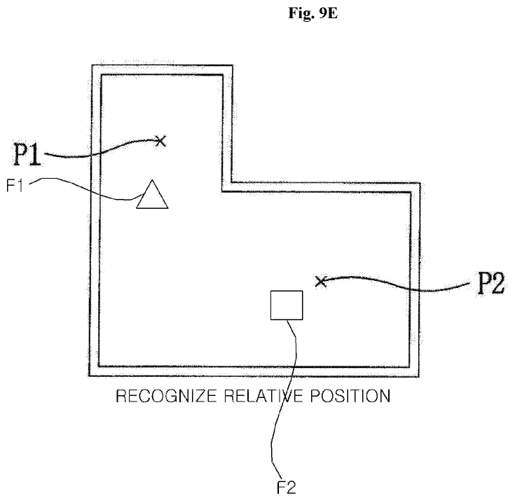

Hereinafter, a calibration process for unifying the coordinate systems of mutually different obstacle maps according to an embodiment of the present disclosure will be described in more detail with reference to FIGS. 8 and 9A to 9E. The calibration of the obstacle maps may include both the case in which one obstacle map is transformed so as to be completely matched with another obstacle map and the case in which all of mutually different obstacle maps are transformed so as to be matched with a reference map.

As a first step of the calibration process, a step of scaling the obstacle map may be performed (101). For example, referring to FIG. 9A, in the case of expansion scaling, the size of each grid square of the second obstacle map Map 2 may be expanded with respect to the center point thereof so as to be the same as that of the first obstacle map MAP 1. Since the conversion of the X-Y coordinates for scaling has been described above, an explanation thereof will be omitted.

In one example, in the case in which the second obstacle map Map 2 is larger than the first obstacle map Map 1, the scaling process may be performed such that the second obstacle map Map 2 is decreased with respect to the center point thereof. Alternatively, the scaling process may be performed on all of the plurality of obstacle maps such that the first obstacle map Map 1 is decreased (expanded) by a constant value and the second obstacle map Map 2 is expanded (decreased) by a constant value. Here, the constant value may be a ratio value determined on the basis of a predetermined coordinate system, at which the obstacle map is decreased or expanded.

Subsequently, as a second step of the calibration process, a step of rotating the obstacle map may be performed (102). The obstacle map may be rotated in a manner similar to rotation of an image. For example, the second obstacle map Map 2 may be rotated 90 degrees to the right, 90 degrees to the left, or 180 degrees, or may be mirrored vertically or horizontally with respect to the current position thereof. However, the present disclosure is not limited thereto. The second obstacle map Map 2 may be rotated a certain rotation angle θ, which is different from the above-mentioned rotation angles. While the second obstacle map Map 2 is rotated, the first obstacle map Map 1 may not be rotated but may remain fixed in order to minimize errors. In the step 102 of rotating the obstacle map, the second obstacle map Map 2 may be rotated such that the shape of the first artificial mark F1 on the first obstacle map Map 1 and the shape of the second artificial mark F2 on the second obstacle map Map 2 are matched with each other.

FIG. 9B shows the case in which the second obstacle map Map 2 is rotated an angle θ to the right, which may be expressed using the following matrix. Here, tₓ and t_{y} are x-y coordinate values *?* before a certain point t is rotated.

$$[ \begin{matrix}cos θ & - sin θ \\ sin θ & cos θ\end{matrix} ] [ \begin{matrix}{t}_{x} \\ {t}_{y}\end{matrix} ]$$

In addition, simultaneously with or immediately after the second step, a step of moving the obstacle map may be performed (103). Referring to FIG. 9C, movement/parallel translation of the obstacle map may be performed such that the x-y coordinate values of the artificial marks on the plurality of obstacle maps are converted so as to be matched with each other and such that the x-axes and/or the y-axes of the obstacle maps are converted so as to correspond to each other using a conversion function.

In one example, the controller 1800 may perform at least one of movement, rotation, or parallel translation on at least one of the plurality of obstacle maps such that the positions and shapes (a triangle and a rectangle) of the first artificial marks F1 are completely matched with the positions and shapes (a triangle and a rectangle) of the second artificial marks F2.

When the scaling step 101, the rotation step 102, and the movement step 103 are performed, the obstacle maps Map 1 and Map 2 completely overlap each other, as shown in FIG. 9D. In this case, although not illustrated, if necessary, boundary regions that do not overlap each other may be cropped so as to revise the obstacle maps Map 1 and Map 2 such that they have exactly the same shape.

Now, the positions of the plurality of mobile robots relative to each other may be recognized in the same coordinate system (104). Referring to FIG. 9E, since the plurality of obstacle maps Map 1 and Map 2 is recognized as a single map due to the unification of the coordinate systems, the position coordinates P1 of the first mobile robot 100a and the position coordinates P2 of the second mobile robot 100b may also be recognized as being marked on a single feature map (a simultaneous localization and mapping (SLAM) map).

Here, the feature map (the simultaneous localization and mapping (SLAM) map) may be a map that a mobile robot generates with respect to the environment of a certain space simultaneously with measuring the positon thereof using only a sensor (e.g. an image sensor, a laser sensor, or the like) installed to a cleaner while traveling in the corresponding space.

As a concrete example, points that are distinctive may be detected from the ceiling or the wall using an image sensor, such as a camera, installed to the mobile robot, and thereafter, the distinctive points may be repeatedly recorded, thereby calculating the position of the cleaner. In addition, the shape of the space may be recorded based on the sensing value sensed by a separate distance sensor from the position of the cleaner calculated using the distance sensor. As a result, the feature map (SLAM) may be generated.

This is distinguished from the “obstacle map” of the present disclosure, which is a grid map that is generated depending on whether the terrain is a terrain on which the mobile robot is capable of traveling based on the actual traveling route, with respect to the designated space in which the mobile robot has traveled earlier once or more.

Although not illustrated, in one embodiment, revision of the map or revision of the coordinates may be additionally performed after the calibration process.

In one example, when the second mobile robot 100b is not capable of traveling a specific region A in a designated space due to a difference in the travel performance between the mobile robots, the map may be revised such that a portion of the second obstacle map Map 2 of the second mobile robot 100b that corresponds to the specific region A is deleted. Alternatively, when only the first mobile robot 100a detects that an obstacle B is present in the designated space due to a difference in the obstacle detection performance between the mobile robots, the coordinates may be revised such that the position or region of the obstacle B, which is detected by only the first mobile robot 100a, is marked on the second obstacle map Map 2 of the second mobile robot 100b.

In this case, a method of transmitting the first obstacle map Map 1 from the first mobile robot 100a to the second mobile robot 100b may also be used.

In addition, in one embodiment, when the calibration for the obstacle maps is completed, the coordinates of the position of the second mobile robot 100b corresponding to a wireless signal received from the second mobile robot 100b may be continuously recognized using the first obstacle map Map 1 of the first mobile robot 100a.

In addition, in one embodiment, not only the current positions of the first mobile robot 100a and the second mobile robot 100b but also the past positions thereof may be marked. That is, the route along which the second mobile robot 100b has traveled may be marked on the first obstacle map Map 1. Accordingly, the initial cooperation scenario may be modified or updated so as to be efficiently performed on the basis of the traveling route of the second mobile robot 100b and the position of the first mobile robot 100a.

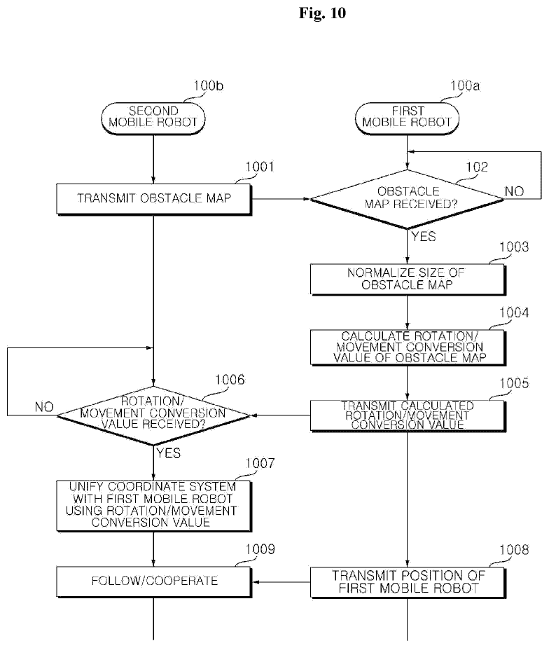

The map calibration process, by which a plurality of mobile robots is capable of recognizing the positions thereof relative to each other in a designated space without a position sensor, has been concretely described above. Hereinafter, another method in which a plurality of mobile robots recognizes the positions thereof relative to each other to perform cooperative/following cleaning operation will be described with reference to FIG. 10.

Referring to FIG. 10, the second mobile robot 100b, which communicates with the first mobile robot 100a, may transmit the obstacle map thereof to the first mobile robot 100a (1001). In this case, the obstacle map may be transmitted in the form of a grid map or an image. Preferably, the obstacle map may have an image form.

In the cooperation relationships between the second mobile robot 100b and the first mobile robot 100a, which receives the obstacle map from the second mobile robot 100b, the first mobile robot 100a may serve as a main cleaner or a sub-cleaner. Subsequently, upon detecting the reception of the obstacle map of the second mobile robot 100b (1002), the first mobile robot 100a may normalize the size of the received obstacle map of the second mobile robot 100b (1003).

Here, the operation of normalizing the size of the obstacle map may be the operation of scaling the size of the obstacle map of the second mobile robot 100b to match the size of the obstacle map of the first mobile robot 100a. Alternatively, the operation of normalizing the size of the obstacle map may be the operation of adjusting both the obstacle map of the second mobile robot 100b and the obstacle map of the first mobile robot 100a to a predetermined scale value. For example, even when the first obstacle map Map 1 of the first mobile robot 100a and the second obstacle map Map 2 of the second mobile robot 100b commonly use grid maps, the size of each grid square of the first obstacle map Map 1 and the size of each grid square of the second obstacle map Map 2 may be different from each other, and thus the operation of normalizing the size of the obstacle map may be required.

In addition, in one example, before the first obstacle map Map 1 is transmitted from the first mobile robot 100a, the size of each grid of the first obstacle map Map 1 may be changed to the actual size, and thereafter, the first obstacle map Map 1 having the changed size may be transmitted to the second mobile robot 100b. In this case, the process of normalizing the size of the first obstacle map Map 1 may be performed earlier than the process of transmitting the first obstacle map Map 1.

When the size of the obstacle map is normalized, a conversion value for rotating/moving the normalized obstacle map may be calculated (1004). The conversion value for rotating/moving the normalized obstacle map may be obtained by applying the X and Y values *?* to the above-described matrix function.

Subsequently, the first mobile robot 100a may transmit the calculated rotation/movement conversion value to the second mobile robot 100b (1005). Upon detecting the reception of the rotation/movement conversion value (1006), the second mobile robot 100b may apply the received rotation/movement conversion value to the obstacle map thereof, thereby unifying the coordinate system of the obstacle map thereof with the coordinate system of the obstacle map of the first mobile robot 100a (1007).

Thereafter, whenever the position of the second mobile robot 100b is changed, the second mobile robot 100b may additionally apply the rotation/movement conversion value to the x and y coordinates thereof, thereby recognizing the position thereof in the same coordinate system as the first mobile robot 100a.

Therefore, when a wireless signal corresponding to the position coordinates is received from the first mobile robot 100a (1008), the second mobile robot 100b may recognize not only the position coordinates thereof but also the position coordinates of the first mobile robot 100a, the coordinate system of which has been unified with that of the second mobile robot 100b, at the same time.

Specifically, the position coordinates of the second mobile robot 100b may be marked in real time on the obstacle map of the second mobile robot 100b, to which the rotation/movement conversion value has been applied. In addition, when a wireless signal corresponding to the position coordinates is received from the first mobile robot 100a, the second mobile robot 100b may mark the coordinates of the relative position of the first mobile robot 100a on the obstacle map thereof, the coordinate system of which has been unified with the obstacle map of the first mobile robot 100a. Accordingly, the second mobile robot 100b may recognize the position coordinates thereof and the relative position coordinates of the first mobile robot 100a in real time.

Subsequently, the second mobile robot 100b may perform following/cooperative cleaning operation based on the information about the position thereof obtained from the obstacle map thereof, the obstacle information, and the relative position of the first mobile robot 100a (1009).

In order to realize this following/cooperative cleaning operation, a cooperation scenario may be generated such that the total traveling route or the total traveling time of the first and second mobile robots 100a and 100b is minimized, using a shortest-route algorithm, such as a Dijkstra algorithm or an A* (A-star) algorithm, based on the detected positions relative to each other. Alternatively, a cooperation scenario may be generated such that the first mobile robot 100a and the second mobile robot 100b separately clean the divided cleaning regions respectively assigned thereto based on the cleaning priorities of the plurality of divided regions and the SoC of the batteries of the first and second mobile robots 100a and 100b.

Although cooperative cleaning using two cleaners has been described above by way of example, the present disclosure is not limited thereto. The embodiments of the present disclosure may also be applied to the case in which three or more cleaners perform cooperative cleaning while detecting the positions thereof relative to one another.

As described above, according to the plurality of autonomous-driving cleaners according to the embodiments of the present disclosure, a plurality of mobile robots may efficiently perform cooperative cleaning while detecting the positions of other mobile robots within a designated space without the necessity to install position sensors thereon.

In addition, even when the mobile robots are of different types from each other and thus use respectively different cleaning maps of the same space, the mobile robots may easily recognize the positions thereof relative to each other without additionally sharing a feature map (a SLAM map). As a result, a cooperation scenario may be efficiently modified or updated according to the positions of the mobile robots relative to each other even while the mobile robots are performing cooperative cleaning.

It will be apparent that, although the preferred embodiments have been shown and described above, the present disclosure is not limited to the above-described specific embodiments, and various modifications and variations can be made by those skilled in the art without departing from the gist of the appended claims. Thus, it is intended that the modifications and variations should not be understood independently of the technical spirit or prospect of the present disclosure.

What is claimed is:

1. A mobile robot comprising:
a driver configured to move a main body;
a memory configured to store a first obstacle map of a cleaning area;
a communication interface configured to communicate with a second mobile robot; and
a controller configured to, when receiving a second obstacle map of the cleaning area from the second mobile robot, perform calibration on the received second obstacle map on a basis of an artificial mark on the stored first obstacle map.

2. The mobile robot of claim 1, wherein the controller performs calibration on the second obstacle map by calculating a conversion value for scaling, rotating, or moving at least one of the first obstacle map or the second obstacle map such that a first artificial mark on the first obstacle map and a second artificial mark on the second obstacle map match each other.

3. The mobile robot of claim 1, wherein the controller performs calibration on the second obstacle map by calculating a conversion value for scaling, rotating, or moving at least one of the first obstacle map or the second obstacle map such that a plurality of first artificial marks on the first obstacle map and a plurality of second artificial marks on the second obstacle map match each other.

4. The mobile robot of claim 1, wherein the controller performs calibration on the second obstacle map by calculating a conversion value for scaling, rotating, or moving at least one of the first obstacle map or the second obstacle map such that a position and a shape of a first artificial mark on the first obstacle map and a position and a shape of a second artificial mark on the second obstacle map match each other.

5. The mobile robot of claim 1, wherein the controller detects a position of the second mobile robot using a second obstacle map on which calibration has been performed, and transmits a cleaning command, generated based on the position of the second mobile robot, and information about a position of the main body to the second mobile robot.

6. The mobile robot of claim 5, wherein the information about a position of the main body is marked on the second obstacle map on which calibration has been performed.

7. The mobile robot of claim 5, wherein the cleaning command transmitted to the second mobile robot is a cleaning command for a specific region selected based on information about a position of the main body, information about an obstacle on the first obstacle map or the second obstacle map, and information about a position of the second mobile robot, or is a cleaning command for instructing the second mobile robot to travel along a route along which the main body has traveled.

8. The mobile robot of claim 5, wherein, when the calibration is completed, the controller recognizes position coordinates of the second mobile robot corresponding to a wireless signal, received from the second mobile robot, using the first obstacle map.

9. The mobile robot of claim 1, further comprising:
a sensor configured to collect information about the artificial mark with respect to the cleaning area.

10. The mobile robot of claim 1, wherein the controller analyzes images collected from the cleaning area, determines an immovable figure among the collected images, and specifies at least one of figures determined to be immovable as an artificial mark.

11. The mobile robot of claim 1, wherein the controller analyzes images collected from the cleaning area, and specifies at least one of figures determined to be marked on a wall or a ceiling among the collected images as an artificial mark.

12. A plurality of mobile robots comprising:
a first mobile robot; and
a second mobile robot,
wherein the first mobile robot receives a second obstacle map of a cleaning area from the second mobile robot, performs calibration on the received second obstacle map on a basis of an artificial mark on a first obstacle map prestored therein, and transmits conversion data corresponding to the calibration to the second mobile robot, and
wherein the second mobile robot applies the conversion data to the second obstacle map thereof, recognizes position coordinates corresponding to a wireless signal received from the first mobile robot, and generates a cleaning command.

13. The plurality of mobile robots of claim 12, wherein the first mobile robot performs calibration on the second obstacle map by calculating a conversion value for scaling, rotating, or moving at least one of the first obstacle map or the second obstacle map such that a first artificial mark on the first obstacle map and a second artificial mark on the second obstacle map match each other.

14. The plurality of mobile robots of claim 12, wherein the first mobile robot performs calibration on the second obstacle map by calculating a conversion value for scaling, rotating, or moving at least one of the first obstacle map or the second obstacle map such that a position and a shape of a first artificial mark on the first obstacle map and a position and a shape of a second artificial mark on the second obstacle map match each other.

15. The plurality of mobile robots of claim 12, wherein the cleaning command is a cleaning command for a specific region selected based on information about a position of the main body, information about an obstacle on the first obstacle map or the second obstacle map, and information about a position of the second mobile robot, or is a cleaning command for instructing the second mobile robot to travel along a route along which the main body has traveled.
